(19) United States
(12) Patent Application Publication
(10) Pub. No.: US 2017/0253331 A1
(43) Pub. Date: Sep. 7, 2017

(54) MULTICOPTER

(71) Applicants: FUTABA CORPORATION, Chiba (JP); O.S.ENGINES MFG. CO., LTD., Osaka (JP)

(72) Inventor: Shuichiro NAKASHIMA, Osaka (JP)

(21) Appl. No.: 15/383,375

(22) Filed: Dec. 19, 2016

(30) Foreign Application Priority Data
Mar. 3, 2016 (JP) 2016-040879

(51) Int. Cl. B64C 39/02; B64C 27/08

(52) U.S. Cl. CPC B64C 39/024; B64C 27/08; B64C 2201/044; B64C 2201/027; B64C 2201/108

(57) ABSTRACT

A multicopter is provided which includes an engine configured to generate rotation by burning fuel in the engine, a plurality of propellers configured to generate a lift by rotating, a rotation transmission path configured to distribute and transmit the rotation generated by the engine to the propellers.

### CROSS REFERENCE TO RELATED APPLICATIONS

This application is based on and claims priority under 35 U.S.C. sctn. 119 with respect to Japanese Patent Application No. 2016-40879 filed on Mar. 3, 2016, the entire content of which is incorporated herein by reference.

### BACKGROUND OF THE INVENTION

This invention relates to a multicopter.

Multicopters (popularly known as “drones”) are unmanned aircraft capable of freely moving in the air and increasingly used these days for birds eye measurements and observations with onboard cameras, transporting articles, and spraying pesticides.

Multicopters include a plurality of propellers, a plurality of electric motors for individually controlling the propellers, and a battery for supplying electric power to the electric motors, and are capable of moving forward or backward, turning right or left, or circling, in the air by individually controlling the plurality of electric motors such that the propellers rotate at different speeds. (One such multicopter is disclosed in JP Patent Publication 2013-510614A (which is hereinafter referred to as “Patent document 1”).)

In a conventional multicopter such as the one disclosed in Patent document 1, if a large battery is used to drive the electric motors, it is possible to extend the flight duration, but its weight capacity (known as “payload”) decreases because the battery is heavy. Conversely, if a small battery is used, while the weight capacity increases, its flight duration shortens. That is, in conventional multicopters which use electric motors to drive the propellers, it is difficult to increase both the flight duration and the payload.

The inventor of the present application considered using engines, instead of electric motors, to drive the respective propellers. Since fuels used for engines are much higher in energy densities than batteries used to drive electric motors, by using engines to drive the propellers of a multicopter, it becomes possible to increase both the flight duration and the payload of the multicopter.

However, since engines, i.e., internal combustion engines, which generate rotations by burning fuel in the engines, are incapable of adjusting rotations generated as finely as electric motors, it is extremely difficult to drive a plurality of the engines in a synchronous manner. Thus, if engines are used to individually drive the respective propellers of a multicopter, it is difficult to stabilize the attitude of the multicopter.

### SUMMARY OF THE INVENTION

An object of the present invention is to provide a multicopter capable of flying for a prolonged period of time, and also capable of carrying a heavier load.

To achieve this object, the present invention provides a multicopter comprising:

an engine configured to generate rotation by burning fuel in the engine;

a plurality of propellers configured to generate a lift by rotating; and

a rotation transmission path configured to distribute and transmit the rotation generated by the engine to the propellers.

With this arrangement, since fuel for the engine is much higher in energy density than a battery used to drive electric motors, it is possible to increase both the flight duration and the payload. Since the output of the engine is distributed to the plurality of propellers to drive the propellers, compared to the arrangement in which the plurality of propellers are driven by separate engines, it is not necessary to drive a plurality of engines in a synchronous manner, so that it is possible to easily stabilize the attitude of the multicopter.

The rotation transmission path may comprise:

a first shaft mechanically coupled to a first propeller of the plurality of propellers;

a second shaft mechanically coupled to a second propeller of the plurality of propellers; and

a differential configured to distribute the rotation generated by the engine to the first and second shafts such that the first and second shafts rotate, respectively, at speeds corresponding to rotational resistances applied to the first and second shafts.

Since a differential is provided between the first shaft mechanically coupled to the first propeller and the second shaft mechanically coupled to the second propeller, it is possible to control the attitude of the multicopter by rotating the first and second propellers at different speeds from each other.

The rotation transmission path may further comprise:

a first brake device configured to apply a braking force to the first shaft; and

a second brake device configured to apply a braking force to the second shaft.

With this arrangement, it is possible to rotate the first shaft and the second shaft at different speeds by applying a braking force to one of the first and second shafts with one of the first and second brake devices.

Each of the first and second brake devices may be a non-contact type brake device comprising a brake disk configured to rotate together with the corresponding one of the first and second shafts, and a stator configured to apply a braking force to the brake disk while being kept out of contact with the brake disk.

With this arrangement, since there is no friction loss between the brake disk and the stator of each brake device, it is possible to reduce energy loss while the first and second brake devices are not actuated, thus effectively increasing the flight duration and the weight capacity of the multicopter.

The first and second brake devices may be regenerative braking devices configured to apply braking forces to the first and second shafts, respectively, by converting torque of the first and second shafts to electric power.

With this arrangement, since the electric power generated by the first and second brake devices is recyclable, power loss is small, so that it is possible to increase the flight duration of the multicopter.

The rotation transmission path may further comprise:

a first auxiliary motor configured to apply torque to the first shaft; and

a second auxiliary motor configured to apply torque to the second shaft.

With this arrangement, it is possible to rotate the first shaft and the second shaft at different speeds by applying torque to one of the first and second shafts with one of the first and second auxiliary motors. Since there is no power loss such as when applying a braking force to one of the first and second shafts, it is possible to increase the flight duration of the multicopter.

By using at least four propellers, it is possible to easily stabilize the attitude of the multicopter. In this case, the rotation transmission path may further comprise:

a third shaft mechanically coupled to a third propeller of the plurality of propellers;

a fourth shaft mechanically coupled to a fourth propeller of the plurality of propellers; and

a second differential configured to distribute the rotation generated by the engine to the third and fourth shafts such that the third and fourth shafts rotate, respectively, at speeds corresponding to rotational resistances applied to the third and fourth shafts.

In this case, the rotation transmission path may further comprise a center differential configured to distribute rotation to the differential configured to distribute rotation to the first and second shafts, and to the second differential.

Preferably, the multicopter further comprises an alternator configured to generate electric power utilizing rotation of the engine, and a battery configured to store the electric power generated by the alternator.

With this arrangement, since electric power generated by the alternator due to revolution of the engine while the multicopter is in the air is stored in the battery, it is possible to use a lightweight battery while ensuring battery power usable while the multicopter is in the air, thus making it possible to further increase the flight duration and the weight capacity of the multicopter.

Any of the above-described differential may include:

a ring gear arranged such that the rotation generated by the engine is applied to the ring gear;

a differential case fixed to the ring gear so as to rotate together with the ring gear;

a pinion provided in the differential case, and supported so as to be rotatable about an axis perpendicular to an axis of the ring gear; and

a pair of side gears each supported so as to be rotatable about an axis parallel to the axis of the ring gear, and meshing with the pinion,

wherein the first shaft is connected to one of the side gears, and the second shaft is connected to the other of the side gears.

Since the multicopter according to the present invention uses an engine as a power source for the propellers, and fuels for engines are much higher in energy density than batteries used for electric motors, the multicopter according to the present invention can stay in the air for a prolonged period of time, and is also capable of carrying a heavier load. Since the engine output is distributed to the plurality of propellers to drive the propellers, that is, the plurality of propellers are not driven separately by a plurality of separate engines, it is not necessary to drive the plurality of engines in a synchronous manner. Thus, it is possible to easily stabilize the attitude of the multicopter.

### BRIEF DESCRIPTION OF THE DRAWINGS

FIG. 1 schematically shows a multicopter according to a first embodiment of the present invention;

FIG. 2 is an enlarged sectional view of a differential shown in FIG. 1;

FIG. 3 schematically shows a multicopter according to a second embodiment of the present invention;

FIG. 4 schematically shows a multicopter according to a third embodiment of the present invention;

FIG. 5 schematically shows a multicopter according to a fourth embodiment of the present invention;

FIG. 6 shows a modification of the first embodiment in which two of the engines as shown in FIG. 1 are arranged such that the rotations generated by the respective engines are transmitted to a common center differential;

FIG. 7 schematically shows another modification of the first embodiment in which a greater number of the propellers shown in FIG. 1 are used; and

FIG. 8 schematically shows a further modification of the first embodiment in which universal joints are mounted in portions of the rotation transmission path extending from the engine shown in FIG. 7 to the respective propellers.

### DETAILED DESCRIPTION OF THE PREFERRED EMBODIMENTS

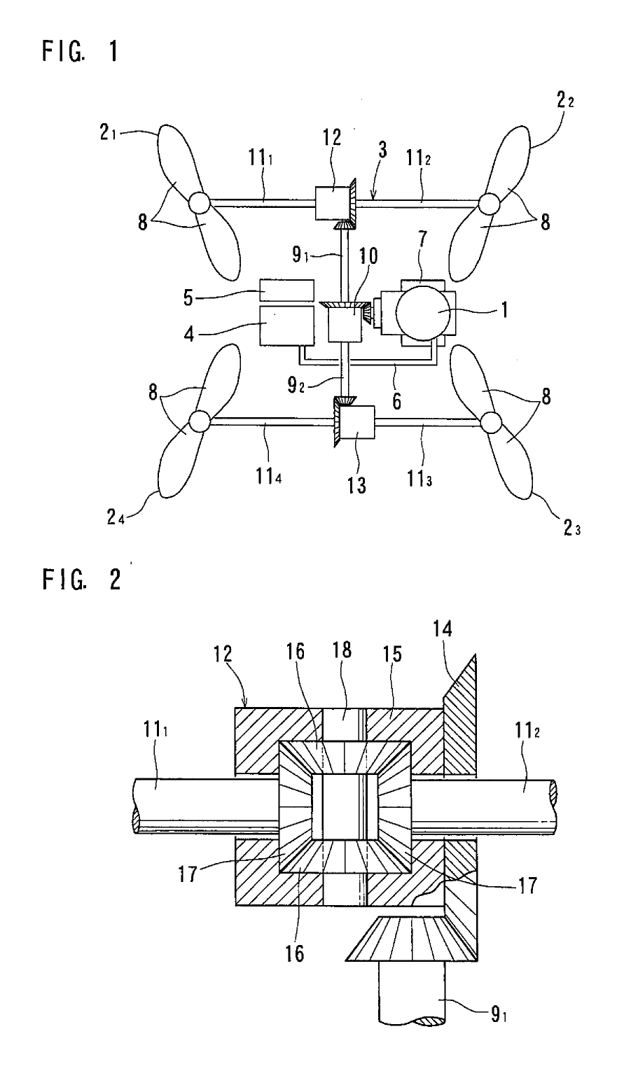

FIG. 1 shows a multicopter according to the first embodiment of the present invention. The multicopter is an unmanned rotorcraft capable of flying in the air to perform measurements and observations with an onboard camera, transport various articles, and spray pesticides. The multicopter includes a single engine 1, first to fourth propellers 2₁, 2₂, 2₃ and 2₄ which generate a lift when rotated, a rotation transmission path 3 which distributes and transmits rotation generated by the engine 1 to the four propellers 2₁, 2₂, 2₃ and 2₄, a fuel tank 4, and a battery 5.

The engine 1 is a driving unit that generates rotation by burning fuel inside the engine 1. The displacement of the engine 1 is determined e.g., within the range of 10-200 cm³. Fuel for the engine 1 is a petroleum-based fuel (such as gasoline). The fuel tank 4 stores fuel to be supplied to the engine 1, and is connected to the engine 1 via a fuel tube 6. The battery 5 is a secondary battery for controlling the engine, and for supplying electric power to e.g. a gyro sensor, not shown. An alternator 7 is fixedly attached to the engine to generate electric power utilizing the rotation of the engine 1. The electric power generated by the alternator 7 is stored in the battery 5.

Each of the first to fourth propellers 2₁, 2₂, 2₃ and 2₄ includes a plurality of blades 8 each extending in a radial direction from the center of rotation of the propeller. Each blade 8 has such a blade angle as to generate a lift when the propeller rotates.

The rotation transmission path 3 includes a center differential 10 which distributes the rotation transmitted from the engine 1 to first and second center shafts 9₁ and 9₂; a differential 12 which distributes the rotation transmitted from the engine 1 via the first center shaft 9₁ to first and second shafts 11₁ and 11₂; and a second differential 13 which distributes the rotation transmitted from the engine 1 via the second center shaft 9₂ to third and fourth shafts 11₃ and 11₄.

The first shaft 11₁ is mechanically coupled to the first propeller 2₁ so that when the first shaft 11₁ rotates, the first propeller 2₁ rotates together with the first shaft 11₁. In the same manner as the first shaft 11₁ is mechanically coupled to the first propeller 2₁, the second shaft 11₂ is mechanically coupled to the second propeller 2₂; the third shaft 11₃ is mechanically coupled to the third propeller 2₃; and the fourth shaft 11₄ is mechanically coupled to the fourth propeller 2₄.

As shown in FIG. 2, the differential 12 includes a ring gear 14 which receives the rotation transmitted from the engine 1 (shown in FIG. 1) via the first center shaft 9₁; a differential case 15 fixed to the ring gear 14 so as to rotate together with the ring gear 14; a pinion shaft 18 fixed to the differential case 15 to extend perpendicular to the center axis of the ring gear 14; pinions 16 located in the differential case 15, and supported by the pinion shaft 18 so as to be rotatable about the pinion shaft 18; and a pair of side gears 17 meshing with the pinions 16. Each side gear 17 is supported by the differential case 15 so as to be rotatable about an axis parallel to the center axis of the ring gear 14. The first shaft 11₁ is connected to one of the side gears 17, while the second shaft 11₂ is connected to the other side gear 17.

The differential 12 is configured to distribute the rotation transmitted from the engine 1 to the first and second shafts 11₁ and 11₂ such that the respective shafts 11₁ and 11₂ rotate at speeds corresponding to the rotational resistances to the respective shafts 11₁ and 11₂. In particular, if the rotational resistance to the first shaft 11₁ is larger than the rotational resistance to the second shaft 11₂, the differential 12 distributes and transmits the rotation of the first center shaft 9₁ to the first and second shafts 11₁ and 11₂ such that the first shaft 11₁ rotates at a lower speed than the second shaft 11₂, and if the rotational resistance to the first shaft 11₁ is smaller than the rotational resistance to the second shaft 11₂, the differential 12 distributes and transmits the rotation of the first center shaft 9₁ to the first and second shafts 11₁ and 11₂ such that the first shaft 11₁ rotates at a higher speed than the second shaft 11₂.

The differential 13 between the third shaft 11₃ and the fourth shaft 11₄, shown in FIG. 1, is of the same structure as the differential 12 between the first shaft 11₁ and the second shaft 11₂. The center differential 10 is also of the same structure as the differential 12.

Since this multicopter uses the engine 1 as the power source of the first to fourth propellers 2₁, 2₂, 2₃ and 2₄, and fuel for the engine 1 has a far higher energy density than a battery used for an electric motor, this multicopter is capable of staying in the air for a prolonged period of time, and/or has a larger weight capacity. Since the output of the single engine 1 is distributed to the plurality of propellers 2₁, 2₂, 2₃ and 2₄ to drive them, it is not necessary to synchronously drive a plurality of engines as in the case when the first to fourth propellers 2₁, 2₂, 2₃ and 2₄ are driven by separate engines. This makes easier to stabilize the attitude of the multicopter.

Since this multicopter has an alternator 7 configured to generate electric power utilizing the rotation of the engine 1, and a battery 5 which is capable of store electric power generated by the alternator 7, it is possible to use a lightweight battery 5 while ensuring available power of the battery 5 during the flight of the multicopter. This serves to effectively increase the flight duration and/or the weight capacity of the multicopter.

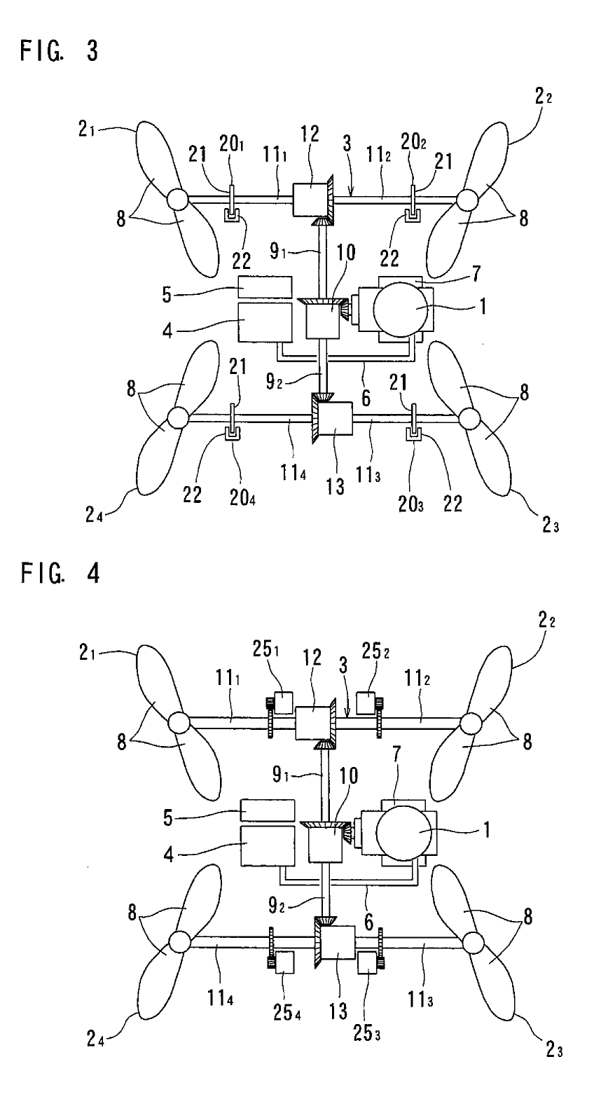

FIG. 3 shows a multicopter of the second embodiment according to the present invention. Here, elements corresponding to those of the first embodiment are denoted by identical numerals and their description is omitted.

The rotation transmission path 3 of the second embodiment includes first to fourth brake devices 20₁, 20₂, 20₃ and 20₄ which apply braking forces to the first to fourth shafts 11₁, 11₂, 11₃ and 11₄, respectively. The first to fourth brake devices 20₁, 20₂, 20₃ and 20₄ are non-contact type brake devices each comprising a brake disk 21 that rotates together with the corresponding one of the first to fourth shafts 11₁, 11₂, 11₃ and 11₄, and a stator 22 configured to apply a braking force to the brake disk 21, while being kept out of contact with the brake disk 21. For example, the brake devices may be eddy current disk brakes.

With the multicopter of the second embodiment, it is possible to apply different rotational resistances to the first to fourth shafts 11₁, 11₂, 11₃ and 11₄, respectively, which are connected together via the differentials 10, 12 and 13, by selectively and individually actuating the first to fourth brake devices 20₁, 20₂, 20₃ and 20₄, thereby rotating the first to fourth propellers 2₁, 2₂, 2₃ and 2₄ at different speeds from each other. Thus in this embodiment, by controlling the braking forces applied to the first to fourth shafts 11₁, 11₂, 11₃ and 11₄, it is possible to control the attitude of the multicopter.

Since the multicopter of the second embodiment uses non-contact type brake devices 20₁, 20₂, 20₃ and 20₄, there is no friction loss between the brake disk 21 and the stator 22 of each brake device, and thus, there will be no energy loss while the first to fourth brake devices 20₁, 20₂, 20₃ and 20₄ are not actuated. This serves to effectively increase the flight duration and the weight capacity of the multicopter.

FIG. 4 shows a multicopter of the third embodiment according to the present invention. Here, elements corresponding to those of the first embodiment are denoted by identical numerals, and their description is omitted.

The rotation transmission path 3 of this embodiment includes first to fourth brake devices 25₁, 25₂, 25₃ and 25₄ which apply braking forces to the first to fourth shafts 11₁, 11₂, 11₃ and 11₄, respectively. The first to fourth brake devices 25₁, 25₂, 25₃ and 25₄ are regenerative braking devices configured to apply braking forces to the first to fourth shafts 11₁, 11₂, 11₃ and 11₄ by converting the torques of the first to fourth shafts 11₁, 11₂, 11₃ and 11₄ to electric power. The first to fourth brake devices 25₁, 25₂, 25₃ and 25₄ are electrically connected to the battery 5 so that the electric power generated during regenerative braking is stored in the battery 5.

The first to fourth brake devices 25₁, 25₂, 25₃ and 25₄ also serve as auxiliary motors capable of selectively and individually applying torques to the first to fourth shafts 11₁, 11₂, 11₃ and 11₄ by receiving electric power from the battery 5.

Thus, the first to fourth propellers 2₁, 2₂, 2₃ and 2₄ of the multicopter of the third embodiment can be rotated at different speeds from each other by selectively actuating the first to fourth brake devices 25₁, 25₂, 25₃ and 25₄ to individually apply braking forces to the first to fourth shafts 11₁, 11₂, 11₃ and 11₄. Alternatively, the first to fourth propellers 2₁, 2₂, 2₃ and 2₄ of the multicopter of the third embodiment can also be rotated at different speeds from each other by selectively actuating the first to fourth brake devices 25₁, 25₂, 25₃ and 25₄ as auxiliary motors to individually apply torques to the first to fourth shafts 11₁, 11₂, 11₃ and 11₄. Thus, in the third embodiment, by controlling the braking forces or torques applied to the first to fourth shafts 11₁, 11₂, 11₃ and 11₄, it is possible to control the attitude of the multicopter.

Since the multicopter of the third embodiment uses regenerative braking devices as the first to fourth brake devices 25₁, 25₂, 25₃ and 25₄, the electric power generated by the brake devices 25₁, 25₂, 25₃ and 25₄ is recyclable, which minimizes energy loss, thus effectively prolonging the flight duration of the multicopter.

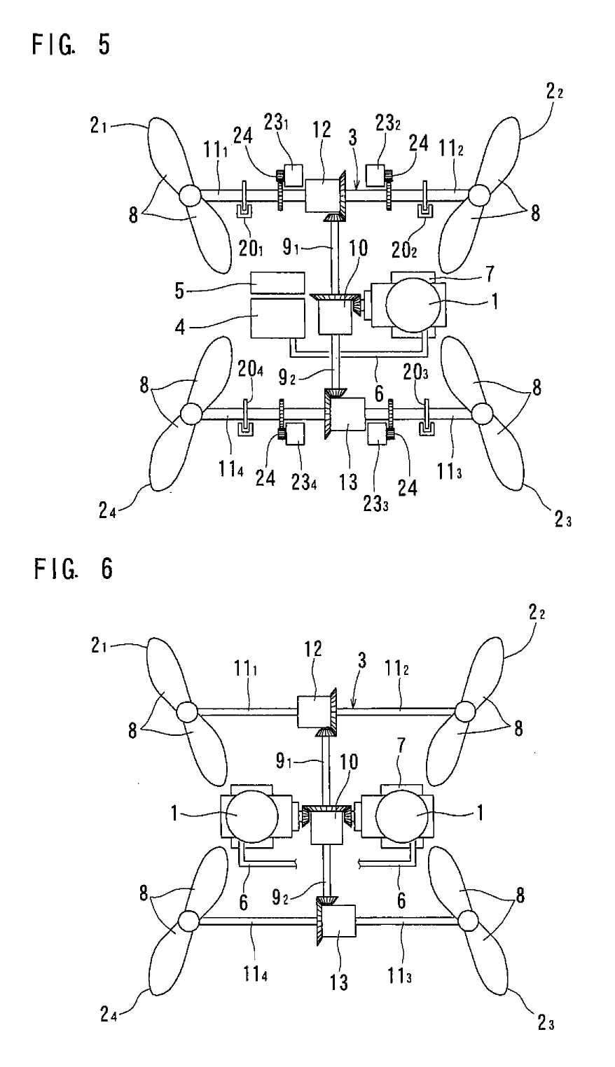

FIG. 5 shows a multicopter of the fourth embodiment according to the present invention. Here, elements corresponding to those of the second embodiment are denoted by identical numerals, and their description is omitted.

The rotation transmission path 3 of this embodiment includes first to fourth auxiliary motors 23₁, 23₂, 23₃ and 23₄ which apply torques to the first to fourth shafts 11₁, 11₂, 11₃ and 11₄, respectively. The rotation transmission path 3 further includes a one-way clutch 24 disposed between the first auxiliary motor 23₁ and the first shaft 11₁ such that the one-way clutch 24 allows transmission of torque that tends to accelerate the rotation of the first shaft 11₁, but prohibits transmission of torque that tends to decelerate the rotation of the first shaft 11₁, from the first auxiliary motor 23₁ to the first shaft 11₁. That is, the one-way clutch 24 is configured and arranged in such a manner that when the first auxiliary motor 23₁ is activated, the one-way clutch 24 engages, thus allowing transmission of torque from the first auxiliary motor 23₁ to the first shaft 11₁, and when the first auxiliary motor 23₁ is deactivated, the one-way clutch 24 disengages, thereby allowing the first shaft 11₁ to rotate independently of the first auxiliary motor 23₁. This prevents the inertia moment of the first auxiliary motor 23₁ from acting on the first shaft 11₁ as rotational resistance when the first auxiliary motor 23₁ stops. One-way clutches 24 identical in structure to, and arranged in the same manner as, the above one-way clutch 24 are provided between the second to fourth auxiliary motors 23₂, 23₃ and 23₄ and the second to fourth shafts 11₂, 11₃ and 11₄, respectively.

Electric power from the battery 5 is used to drive the first to fourth auxiliary motors 23₁, 23₂, 23₃ and 23₄. Alternatively, however, electric power generated by the alternator 7 may be used to drive the first to fourth auxiliary motors 23₁, 23₂, 23₃ and 23₄. In particular, electric power generated by the alternator 7 while the engine 1 is running may be stored in the battery 5, while simultaneously, electric power from the battery 5 may be used to drive the first to fourth auxiliary motors 23₁, 23₂, 23₃ and 23₄.

Thus, in the fourth embodiment, rotational resistances applied to the first to fourth shafts 11₁, 11₂, 11₃ and 11₄ can be altered individually by selectively actuating the first to fourth auxiliary motors 23₁, 23₂, 23₃ and 23₄, thereby individually applying torques to the first to fourth shafts 11₁, 11₂, 11₃ and 11₄. Thus, the attitude of the multicopter of the fourth embodiment can be controlled by controlling the torques applied to the first to fourth shafts 11₁, 11₂, 11₃ and 11₄. It is also possible to individually decelerate the rotations of the first to fourth propellers 2₁, 2₂, 2₃ and 2₄ by selectively actuating the first to fourth brake devices 20₁, 20₂, 20₃ and 20₄.

Since the multicopter of the fourth embodiment is configured such that the first to fourth shafts 11₁, 11₂, 11₃ and 11₄ are rotated at different speeds by applying torques to the first to fourth shafts 11₁, 11₂, 11₃ and 11₄, energy loss is small compared to the arrangement in which the rotational speeds of the first to fourth shafts 11₁, 11₂, 11₃ and 11₄ are controlled by applying braking forces thereto, so that it is possible to effectively prolong the flight duration of the multicopter.

While the multicopter of each of the above-described embodiments uses a single engine 1, two engines 1 may be used, as shown in FIG. 6, so that the rotations of the two engines 1 are applied simultaneously to the (single) center differential 10. With this arrangement, redundancy of the multicopter improves because even if one of the two engines 1 unexpectedly stops, the propellers 2₁, 2₂, 2₃ and 2₄ can still be driven by the other engine.

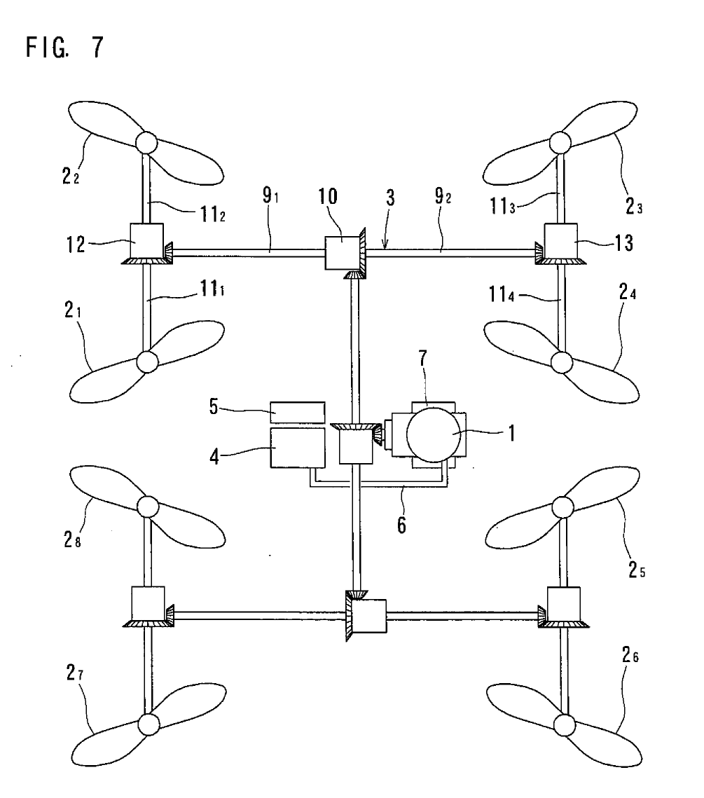

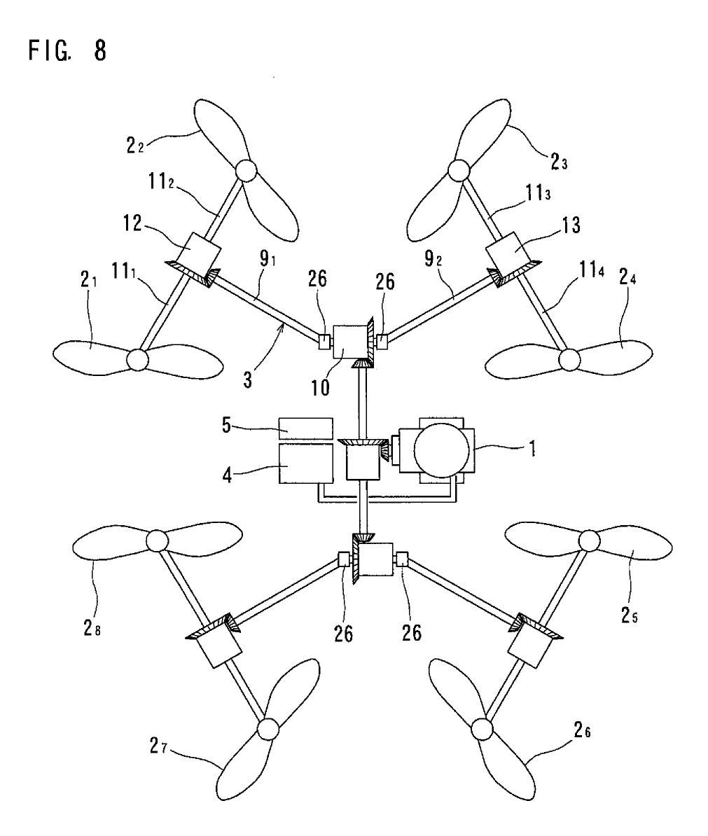

While the multicopter of each of the above-described embodiments uses four propellers 2, the present invention is applicable to a multicopter including more than four propellers. For example, as shown in FIGS. 7 and 8, the present invention is applicable to multicopters including eight propellers 2₁-2₈. The multicopter shown in FIG. 8 includes universal joints 26 mounted in the rotation transmission path 3, which extends from the engine 1 to the propellers 2₁-2₈. The universal joints 26 allow a large number of propellers, such as the eight propellers 2₁-2₈, to be arranged on a common circle (or on a common oval as shown).

It is to be understood that the embodiments shown are mere examples and do not restrict the invention in every respect. The scope of the present invention should be construed based on the appended claims and not based on the description. It is further to be understood that the present invention covers every modification within the range equivalent in meaning to what is recited in the claims.

What is claimed is:

1. A multicopter comprising:
an engine configured to generate rotation by burning fuel in the engine;
a plurality of propellers configured to generate a lift by rotating; and
a rotation transmission path configured to distribute and transmit the rotation generated by the engine to the propellers.

2. The multicopter of claim 1, wherein the rotation transmission path comprises:
a first shaft mechanically coupled to a first propeller of the plurality of propellers;
a second shaft mechanically coupled to a second propeller of the plurality of propellers; and
a differential configured to distribute the rotation generated by the engine to the first and second shafts such that the first and second shafts rotate, respectively, at speeds corresponding to rotational resistances applied to the first and second shafts.

3. The multicopter of claim 2, wherein the rotation transmission path further comprises:
a first brake device configured to apply a braking force to the first shaft; and
a second brake device configured to apply a braking force to the second shaft.

4. The multicopter of claim 3, wherein each of the first and second brake devices is a non-contact type brake device comprising a brake disk configured to rotate together with a corresponding one of the first and second shafts, and a stator configured to apply a braking force to the brake disk while being kept out of contact with the brake disk.

5. The multicopter of claim 3, wherein the first and second brake devices are regenerative braking devices configured to apply braking forces to the first and second shafts, respectively, by converting torque of the first and second shafts to electric power.

6. The multicopter of claim 2, wherein the rotation transmission path further comprises:
a first auxiliary motor configured to apply torque to the first shaft; and
a second auxiliary motor configured to apply torque to the second shaft.

7. The multicopter of claim 2, wherein the plurality of propellers comprises at least four propellers, and the rotation transmission path further comprises:
a third shaft mechanically coupled to a third propeller of the plurality of propellers;
a fourth shaft mechanically coupled to a fourth propeller of the plurality of propellers; and
a second differential configured to distribute the rotation generated by the engine to the third and fourth shafts such that the third and fourth shafts rotate, respectively, at speeds corresponding to rotational resistances applied to the third and fourth shafts.

8. The multicopter of claim 3, wherein the plurality of propellers comprises at least four propellers, and the rotation transmission path further comprises:
a third shaft mechanically coupled to a third propeller of the plurality of propellers;
a fourth shaft mechanically coupled to a fourth propeller of the plurality of propellers; and
a second differential configured to distribute the rotation generated by the engine to the third and fourth shafts such that the third and fourth shafts rotate, respectively, at speeds corresponding to rotational resistances applied to the third and fourth shafts.

9. The multicopter of claim 4, wherein the plurality of propellers comprises at least four propellers, and the rotation transmission path further comprises:
a third shaft mechanically coupled to a third propeller of the plurality of propellers;
a fourth shaft mechanically coupled to a fourth propeller of the plurality of propellers; and
a second differential configured to distribute the rotation generated by the engine to the third and fourth shafts such that the third and fourth shafts rotate, respectively, at speeds corresponding to rotational resistances applied to the third and fourth shafts.

10. The multicopter of claim 5, wherein the plurality of propellers comprises at least four propellers, and the rotation transmission path further comprises:
a third shaft mechanically coupled to a third propeller of the plurality of propellers;
a fourth shaft mechanically coupled to a fourth propeller of the plurality of propellers; and
a second differential configured to distribute the rotation generated by the engine to the third and fourth shafts such that the third and fourth shafts rotate, respectively, at speeds corresponding to rotational resistances applied to the third and fourth shafts.

11. The multicopter of claim 6, wherein the plurality of propellers comprises at least four propellers, and the rotation transmission path further comprises:
a third shaft mechanically coupled to a third propeller of the plurality of propellers;
a fourth shaft mechanically coupled to a fourth propeller of the plurality of propellers; and
a second differential configured to distribute the rotation generated by the engine to the third and fourth shafts such that the third and fourth shafts rotate, respectively, at speeds corresponding to rotational resistances applied to the third and fourth shafts.

12. The multicopter of claim 7, wherein the rotation transmission path further comprises a center differential configured to distribute rotation to the differential configured to distribute rotation to the first and second shafts, and to the second differential.

13. The multicopter of claim 1, further comprising an alternator configured to generate electric power utilizing rotation of the engine, and a battery configured to store the electric power generated by the alternator.

14. The multicopter of claim 2, wherein the differential includes:
a ring gear arranged such that the rotation generated by the engine is applied to the ring gear;
a differential case fixed to the ring gear so as to rotate together with the ring gear;
a pinion provided in the differential case, and supported so as to be rotatable about an axis perpendicular to an axis of the ring gear; and
a pair of side gears each supported so as to be rotatable about an axis parallel to the axis of the ring gear, and meshing with the pinion,
wherein the first shaft is connected to one of the side gears, and the second shaft is connected to the other of the side gears.

15. The multicopter of claim 3, wherein the differential includes:
a ring gear arranged such that the rotation generated by the engine is applied to the ring gear;
a differential case fixed to the ring gear so as to rotate together with the ring gear;
a pinion provided in the differential case, and supported so as to be rotatable about an axis perpendicular to an axis of the ring gear; and
a pair of side gears each supported so as to be rotatable about an axis parallel to the axis of the ring gear, and meshing with the pinion,
wherein the first shaft is connected to one of the side gears, and the second shaft is connected to the other of the side gears.

16. The multicopter of claim 4, wherein the differential includes:
a ring gear arranged such that the rotation generated by the engine is applied to the ring gear;
a differential case fixed to the ring gear so as to rotate together with the ring gear;
a pinion provided in the differential case, and supported so as to be rotatable about an axis perpendicular to an axis of the ring gear; and
a pair of side gears each supported so as to be rotatable about an axis parallel to the axis of the ring gear, and meshing with the pinion,
wherein the first shaft is connected to one of the side gears, and the second shaft is connected to the other of the side gears.

17. The multicopter of claim 5, wherein the differential includes:
a ring gear arranged such that the rotation generated by the engine is applied to the ring gear;
a differential case fixed to the ring gear so as to rotate together with the ring gear;
a pinion provided in the differential case, and supported so as to be rotatable about an axis perpendicular to an axis of the ring gear; and
a pair of side gears each supported so as to be rotatable about an axis parallel to the axis of the ring gear, and meshing with the pinion,
wherein the first shaft is connected to one of the side gears, and the second shaft is connected to the other of the side gears.

18. The multicopter of claim 6, wherein the differential includes:
a ring gear arranged such that the rotation generated by the engine is applied to the ring gear;
a differential case fixed to the ring gear so as to rotate together with the ring gear;
a pinion provided in the differential case, and supported so as to be rotatable about an axis perpendicular to an axis of the ring gear; and
a pair of side gears each supported so as to be rotatable about an axis parallel to the axis of the ring gear, and meshing with the pinion,
wherein the first shaft is connected to one of the side gears, and the second shaft is connected to the other of the side gears.

19. The multicopter of claim 7, wherein the differential configured to distribute rotation to the first and second shafts includes:
a ring gear arranged such that the rotation generated by the engine is applied to the ring gear;
a differential case fixed to the ring gear so as to rotate together with the ring gear;
a pinion provided in the differential case, and supported so as to be rotatable about an axis perpendicular to an axis of the ring gear; and
a pair of side gears each supported so as to be rotatable about an axis parallel to the axis of the ring gear, and meshing with the pinion,
wherein the first shaft is connected to one of the side gears, and the second shaft is connected to the other of the side gears.

20. The multicopter of claim 8, wherein the differential configured to distribute rotation to the first and second shafts includes:
a ring gear arranged such that the rotation generated by the engine is applied to the ring gear;
a differential case fixed to the ring gear so as to rotate together with the ring gear;
a pinion provided in the differential case, and supported so as to be rotatable about an axis perpendicular to an axis of the ring gear; and
a pair of side gears each supported so as to be rotatable about an axis parallel to the axis of the ring gear, and meshing with the pinion,
wherein the first shaft is connected to one of the side gears, and the second shaft is connected to the other of the side gears.
